(19) United States
(12) Patent Application Publication
(10) Pub. No.: US 2004/0059042 A1
(43) Pub. Date: Mar. 25, 2004

(54) Underhood components

(76) Inventors: Thomas J. Hartle, Delmar, NY (US); Michael Edward Price, Pinckney, MI (US)

Correspondence Address: CANTOR COLBURN, LLP, 55 GRIFFIN ROAD SOUTH, BLOOMFIELD, CT, 06002

(21) Appl. No.: 10/667,265

(22) Filed: Sep. 19, 2003

Related U.S. Application Data
(60) Provisional application No. 60/319,564, filed on Sep. 20, 2002.

(51) Int. Cl. C08J 3/00

(52) U.S. Cl. 524/500

(57) ABSTRACT

An under hood component comprising a poly(arylene ether)/polyolefin blend; a reinforced polyolefin; a reinforced poly(arylene ether)/polyolefin blend or a combination of two or more of the foregoing.

### CROSS REFERENCE TO RELATED APPLICATIONS

This application claims the benefits of U.S. Provisional Patent Application Serial No. 60/319,564, filed Sep. 20, 2002, which is fully incorporated herein by reference.

### BACKGROUND OF INVENTION

This disclosure relates to materials useful for under hood components. In particular it relates to thermoplastic compositions useful for under hood components.

The under hood environment presents a number of challenges with regard to useful materials. In general the materials are required to have high strength at elevated temperatures, good dimensional stability in the under hood environment as well as good chemical resistance. Examples of under hood components include radiator end caps, power steering reservoirs, thermostat housings, battery trays, air filter housings and engine covers. Thermoplastic materials with suitable properties offer an attractive solution to the challenges of the under hood environment.

In particular, radiator end caps function in a harsh chemical environment. They are in continuous contact with radiator fluid at elevated temperatures and pressures for extended periods of time. Radiator fluid, particularly extended life radiator fluids, can contain acidic compounds that may, over time, negatively impact the physical properties of the radiator end cap. Consequently radiator end caps need to be constructed from high strength, high stiffness materials with excellent chemical resistance.

Some of the first materials used for radiator end caps were metals. While metals offered high strength and high stiffness, the chemical resistance was, at times, problematic. Additionally, metals were also heavy and expensive. Attention then turned to polymeric materials such as filled polyamide. Filled polyamides offer lower specific gravity (less weight) and are less expensive when compared to metal. Also, polyamides have high strength at high temperatures and good chemical resistance to some of the chemicals found in the under the hood environment. Unfortunately, polyamides can be susceptible to hydrolysis and acidic attack in the under hood environment, resulting in a loss of strength.

### SUMMARY OF INVENTION

The above described and other drawbacks and disadvantages of the prior art are alleviated by an under hood component, comprising a poly(arylene ether)/polyolefin blend, a reinforced poly(arylene ether)/polyolefin blend or a combination of the foregoing.

In another embodiment a radiator end cap comprises a poly(arylene ether)/polyolefin blend, a reinforced polyolefin, a reinforced poly(arylene ether)/polyolefin blend or a combination of two or more of the foregoing.

### DETAILED DESCRIPTION

A thermoplastic composition useful for under hood components having good dimensional stability, an excellent balance of stiffness and impact strength, as well as excellent chemical resistance, comprises a poly(arylene ether)/polyolefin blend; a reinforced polyolefin; or a reinforced poly(arylene ether)/polyolefin blend. A reinforced poly(arylene ether)/polyolefin blend is herein defined as having filler incorporated into the composition. Similarly, a reinforced polyolefin is herein defined as having filler incorporated into the composition. When the thermoplastic resin comprises a poly(arylene ether)/polyolefin blend it may also include an optional hydrogenated alkenyl aromatic compound/conjugated diene block copolymer, an optional unhydrogenated alkenyl aromatic compound/conjugated diene block copolymer or a combination of hydrogenated and unhydrogenated alkenyl aromatic compound/conjugated diene block copolymers. The poly(arylene ether) component of the blend may further comprise a poly(alkenyl aromatic) resin. The poly(arylene ether)/polyolefin blend, the reinforced poly(arylene ether)/polyolefin blend, and the reinforced polyolefin offer a under hood components with high strength, particularly at temperatures above room temperature, good impact resistance, and excellent hydrolytic stability.

Under hood components, in addition to radiator end caps, that may require the above mentioned physical properties include, but are not limited to, power steering fluid reservoirs, radiation fluid surge tanks, thermostat housings, battery trays, air filter housings, and engine covers.

The poly(arylene ether)/polyolefin blend and the reinforced poly(arylene ether)/polyolefin blend generally comprise the same resin components. The difference between the poly(arylene ether)/polyolefin blend and the reinforced poly(arylene ether)/polyolefin blend is the presence/absence of filler and optional filler associated additives. Hereinafter, when discussing the resin components, no distinction will be made between poly(arylene ether)/polyolefin blend and reinforced poly(arylene ether)/polyolefin blend.

The term poly(arylene ether) includes polyphenylene ether (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s are known polymers comprising a plurality of structural units of the formula

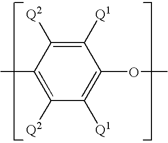

wherein for each structural unit, each Q¹ is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms. Preferably, each Q¹ is alkyl or phenyl, especially C₁₋₄ alkyl, and each Q² is independently hydrogen or methyl.

Both homopolymer and copolymer poly(arylene ether)s are included. The preferred homopolymers are those comprising 2,6-dimethylphenylene ether units. Suitable copolymers include random copolymers comprising, for example, such units in combination with 2,3,6-trimethyl-1,4-phenylene ether units or copolymers derived from copolymerization of 2,6-dimethylphenol with 2,3,6-trimethylphenol. Also included are poly(arylene ether)s containing moieties prepared by grafting vinyl monomers or polymers such as polystyrenes, as well as coupled poly(arylene ether) in which coupling agents such as low molecular weight polycarbonates, quinones, heterocycles and formals undergo reaction in known manner with the hydroxy groups of two poly(arylene ether) chains to produce a higher molecular weight polymer. Poly(arylene ether)s further include combinations of any of the above.

The poly(arylene ether) generally has a number average molecular weight of about 3,000 to about 40,000 atomic mass units (AMU) and a weight average molecular weight of about 20,000 to about 80,000 AMU, as determined by gel permeation chromatography. The poly(arylene ether) generally may have an intrinsic viscosity of about 0.1 to about 0.6 deciliters per gram (dL/g) as measured in chloroform at 25° C. Within this range, the intrinsic viscosity may preferably be less than or equal to about 0.5 dL/g, more preferably less than or equal to about 0.47 dL/g. Also within this range, the intrinsic viscosity may preferably be greater than or equal to about 0.3 dL/g. It is also possible to utilize a high intrinsic viscosity poly(arylene ether) and a low intrinsic viscosity poly(arylene ether) in combination. Determining an exact ratio, when two intrinsic viscosities are used, will depend on the exact intrinsic viscosities of the poly(arylene ether)s used and the ultimate physical properties desired.

The poly(arylene ether)s are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether)s for many purposes include those that comprise molecules having at least one aminoalkyl-containing group. The aminoalkyl radical is typically located in an ortho position relative to the hydroxy group or ether linkage. Products containing such end groups may be obtained by incorporating an appropriate primary or secondary monoamine such as di-n-butylamine or dimethylamine as one of the constituents of the oxidative coupling reaction mixture. The amount of the aminoalkyl containing group varies widely and can be as much as 5000 parts per million (ppm). Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of the aminoalkyl-containing and 4-hydroxybiphenyl end groups.

The poly(arylene ether)/polyolefin blend may comprise poly(arylene ether) in an amount of about 5 to about 95 weight percent, based on the total weight of the blend. Within this range, it may be preferred to use the poly(arylene ether) in an amount greater than or equal to about 15 weight percent, more preferably greater than or equal to about 20 weight percent. It may also be preferred to use the poly(arylene ether) in an amount less than or equal to about 70 weight percent, more preferably less than or equal to about 50 weight percent.

The poly(arylene ether) employed in the blend may comprise a poly(alkenyl aromatic) resin. The term “poly(alkenyl aromatic) resin” as used herein includes polymers prepared by methods known in the art including bulk, suspension, and emulsion polymerization, which contain at least 25% by weight of structural units derived from an alkenyl aromatic monomer of the formula

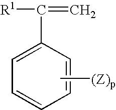

wherein R¹ is hydrogen, C₁-C₈ alkyl, halogen, or the like; Z is vinyl, halogen, C₁-C₈ alkyl, or the like; and p is 0 to 5. Preferred alkenyl aromatic monomers include styrene, chlorostyrene, and vinyltoluene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ monaromatic diene monomer, such as butadiene or isoprene. The rubber-modified poly(alkenyl aromatic) resin may comprise about 98 to about 70 weight percent of the homopolymer of an alkenyl aromatic monomer and about 2 to about 30 weight percent of the rubber modifier. Within these ranges it may be preferred to use at least 88 weight percent of the alkenyl aromatic monomer. It may also be preferred to use less than or equal to about 94 weight percent of the alkenyl aromatic monomer. It may also be preferred to use at least 6 weight percent of the rubber modifier. It may also be preferred to use up to 12 weight percent of the rubber modifier.

The stereoregularity of the poly(alkenyl aromatic) resin may be atactic or syndiotactic. Highly preferred poly(alkenyl aromatic) resins include atactic and syndiotactic homopolystyrenes. Suitable atactic homopolystyrenes are commercially available as, for example, EB3300 from Chevron, and P1800 from BASF. Suitable syndiotactic homopolystyrenes are commercially available, for example, under the tradename QUESTRA® (e.g., QUESTRA® WA550) from Dow Chemical Company. Preferred poly(alkenyl aromatic) resins include the rubber-modified polystyrenes, also known as high-impact polystyrenes or HIPS, comprising about 88 to about 94 weight percent polystyrene and about 6 to about 12 weight percent polybutadiene, with an effective gel content of about 10% to about 35%. These rubber-modified polystyrenes are commercially available as, for example, GEH 1897 from General Electric Plastics, and BA 5350 from Chevron.

The poly(arylene ether)/polyolefin blend may comprise the poly(alkenyl aromatic) resin, when present, in an amount of about 1 to about 70 weight percent, based on the total weight of the blend. Within this range, it may be preferred to use the poly(alkenyl aromatic) resin in an amount greater than or equal to about 3 weight percent, more preferably greater than or equal to about 5 weight percent.

Alternatively, the amount of poly(alkenyl aromatic) resin may be expressed as a fraction of the total of poly(arylene ether) and poly(alkenyl aromatic) resin. The blend may preferably comprise poly(alkenyl aromatic) resin in an amount of about 1 to about 80 weight percent, based on the combined weight of poly(arylene ether) and poly(alkenyl aromatic) resin. Within this range, it may be preferred to use a poly(alkenyl aromatic) resin amount less than or equal to about 70 weight percent, more preferably less than or equal to about 65 weight percent. Also within this range, it may be preferred to use a poly(alkenyl aromatic) resin amount greater than or equal to about 20 weight percent, more preferably greater than or equal to about 30 weight percent. When the amount of poly(alkenyl aromatic) resin is greater than about 80 weight percent of the total of the poly(arylene ether) and poly(alkenyl aromatic) resin, the composition after molding may be deficient in heat distortion temperature. The proportions of poly(alkenyl aromatic) resin and poly(arylene ether) may be manipulated to control the glass transition temperature (T_{g}) of the single phase comprising these two components relative to the T_{g} of the poly(arylene ether) alone, or relative to the melting temperature (Tₘ) of the polyolefin alone. For example, the relative amounts of poly(alkenyl aromatic) resin and poly(arylene ether) may be chosen so that the poly(arylene ether) and the poly(alkenyl aromatic) resin form a single phase having a glass transition temperature greater than or equal to about 20° C. greater, preferably greater than or equal to about 30° C. greater, than the glass transition temperature of the poly(alkenyl aromatic) resin alone, which may be, for example, about 100° C. to about 110° C. Also, the relative amounts of poly(alkenyl aromatic) resin and poly(arylene ether) may be chosen so that the poly(arylene ether) and the poly(alkenyl aromatic) resin are present in a single phase having a glass transition temperature less than or equal to about 15° C. greater, preferably less than or equal to about 10° C. greater, more preferably less than or equal to about 1° C. greater, than the Tₘ of the polyolefin alone. In one embodiment, the relative amounts of poly(alkenyl aromatic) resin and poly(arylene ether) may be chosen so that the poly(arylene ether) and the poly(alkenyl aromatic) resin are present in a single phase having a glass transition temperature of about 130° C. to about 180° C.

The polyolefin may be a homopolymer or copolymer having greater than or equal to about 80 weight percent of units derived from polymerization of ethylene, propylene, butylene, or a mixture thereof. Examples of polyolefin homopolymers include polyethylene, polypropylene, and polybutylene. Examples of polyolefin copolymers include random, graft, and block copolymers of ethylene, propylene, and butylene with each other, and further comprising up to 20 weight percent of units derived from C₄-C₁₀ alpha olefins (excluding aromatic alpha-olefins). Polyolefins further include blends of the above homopolymers and copolymers. In some instances, preferred polyolefins may have a flexural modulus greater than or equal to about 100,000 pounds per square inch (psi) at 23° C. as measured according to ASTM D790. In other instances, polyolefins may be combined in order to achieve a particular melt flow index (MFI). Suitable polyolefins may comprise, for example, the linear low density polyethylene available from ExxonMobil as LL-6201, the low density polyethylene available from ExxonMobil as LMA-027, the high density polyethylene available from ExxonMobil as HD-6605, the ultra-high molecular weight polyethylene available as Type 1900 from Montell Polyolefins, and the polybutylene (polybutene-1) available as PB0110 from Montell Polyolefins.

Preferred polyolefins include propylene polymers. The propylene polymer may be a homopolymer of polypropylene. Alternatively, the propylene polymer may be a random, graft, or block copolymer of propylene and at least one olefin selected from ethylene and C₄-C₁₀ alpha-olefins (excluding aromatic alpha-olefins), with the proviso that the copolymer comprises greater than or equal to about 80 weight percent, preferably greater than or equal to about 90 weight percent, of repeating units derived from propylene. Blends of such propylene polymers with a minor amount of another polymer such as polyethylene are also included within the scope of propylene polymers. The propylene polymer may have a melt flow index of about 0.1 to about 100 g/10 min, preferably about 1 to about 40 g/10 min when measured according to ASTM D1238 at 2.16 kg and 200° C. The above-described propylene polymers can be produced by various known processes. Commercially available propylene polymers may also be employed.

Preferred propylene polymers include homopolypropylenes. Highly preferred propylene polymers include homopolypropylenes having a crystalline content greater than or equal to about 20%, preferably greater than or equal to about 30%. Suitable isotactic polypropylenes are commercially available as, for example, PD403 pellets from Basell (formerly Montell Polyolefins of North America). It is also contemplated that high crystalline homopolypropylenes having a flexural modulus of greater than 250,000 psi at 23° C. as measured by ASTM D790 may be useful.

The poly(arylene ether)/polyolefin blend may comprise polyolefin in an amount of about 5 to about 95 weight percent, based on the total weight of the blend. Within this range, a polyolefin amount greater than or equal to about 15 weight percent may be preferred. Also within this range, a polyolefin amount less than or equal to about 85 weight percent may be preferred, and an amount less than or equal to about 70 weight percent may be more preferred. When the thermoplastic composition comprises a reinforced polyolefin, the amount of polyolefin is about 20 to about 90 weight percent, based on the total weight of the composition. Within this range, a polyolefin amount greater than or equal to about 50 weight percent may be preferred. Also within this range, a polyolefin amount less than or equal to about 80 weight percent may be preferred, and an amount less than or equal to about 70 weight percent may be more preferred.

Thermoplastic compositions useful for under hood components comprising a poly(arylene ether)/polyolefin blend may also comprise a hydrogenated alkenyl aromatic compound/conjugated diene block copolymer having an alkenyl aromatic content of about 25 to about 90 weight percent (hereinafter referred to as the “hydrogenated block copolymer”). The hydrogenated block copolymer is a copolymer comprising (A) at least one block derived from an alkenyl aromatic compound and (B) at least one block derived from a conjugated diene, in which the aliphatic unsaturated group content in the block (B) is reduced by hydrogenation. The arrangement of blocks (A) and (B) includes a linear structure, a grafted structure, and a radial teleblock structure having a branched chain.

Preferred among these structures are linear structures embracing diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B. More preferred are diblock, triblock, and tetrablock structures, with the A-B-A triblock structure being particularly preferred.

The alkenyl aromatic compound providing the block (A) is represented by formula

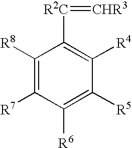

wherein R² and R³ each independently represent a hydrogen atom, a C₁-C₈ alkyl group, a C₂-C₈ alkenyl group, or the like; R⁴ and R⁸ each independently represent a hydrogen atom, a C₁-C₈ alkyl group, a chlorine atom, a bromine atom, or the like; and R⁵-R⁷ each independently represent a hydrogen atom, a C₁-C₈ alkyl group, a C₂-C₈ alkenyl group, or the like, or R⁴ and R⁵ are taken together with the central aromatic ring to form a naphthyl group, or R⁵ and R⁶ are taken together with the central aromatic ring to form a naphthyl group.

Specific examples, of the alkenyl aromatic compounds include styrene, p-methylstyrene, alpha-methylstyrene, vinylxylenes, vinyltoluenes, vinylnaphthalenes, divinylbenzenes, bromostyrenes, chlorostyrenes, and the like, and combinations comprising at least one of the foregoing alkenyl aromatic compounds. Of these, styrene, alpha-methylstyrene, p-methylstyrene, vinyltoluenes, and vinylxylenes are preferred, with styrene being more preferred.

Specific examples of the conjugated diene include 1,3-butadiene, 2-methyl-1,3-butadiene, 2,3-dimethyl-1,3-butadiene, 1,3-pentadiene, and the like. Preferred among them are 1,3-butadiene and 2-methyl-1,3-butadiene, with 1,3-butadiene being more preferred.

In addition to the conjugated diene, the hydrogenated block copolymer may contain a small proportion of a lower olefinic hydrocarbon such as, for example, ethylene, propylene, 1-butene, dicyclopentadiene, a non-conjugated diene, or the like.

The content of the repeating unit derived from the alkenyl aromatic compound in the hydrogenated block copolymer may be about 40 to about 90 weight percent, based on the total weight of the hydrogenated block copolymer, with the lower limit of the alkenyl aromatic compound content preferably being about 50 weight percent, more preferably about 55 weight percent, and with the upper limit of the alkenyl aromatic compound content preferably being less than or equal to about 85 weight percent, more preferably less than or equal to about 75 weight percent, yet more preferably less than or equal to about 70 weight percent.

There is no particular limitation on the mode of incorporation of the conjugated diene in the hydrogenated block copolymer backbone. For example, when the conjugated diene is 1,3-butadiene, it may be incorporated with about 1% to about 99% 1,2-incorporation, with the remainder being 1,4-incorporation.

The hydrogenated block copolymer is preferably hydrogenated to such a degree that fewer than 50%, more preferably fewer than 20%, yet more preferably fewer than 10%, of the unsaturated bonds in the aliphatic chain moiety derived from the conjugated diene remain unreduced. The aromatic unsaturated bonds derived from the alkenyl aromatic compound may be hydrogenated to a degree less than or equal to about 25%.

The hydrogenated block copolymer preferably has a number average molecular weight of about 5,000 to about 500,000 AMU, as determined by gel permeation chromatography (GPC) using polystyrene standards. Within this range, the number average molecular weight is preferably greater than or equal to about 10,000 AMU, more preferably greater than or equal to about 30,000 AMU, yet more preferably greater than or equal to about 45,000 AMU. Also within this range, the number average molecular weight is preferably less than or equal to about 300,000 AMU, more preferably less than or equal to about 200,000 AMU, yet more preferably less than or equal to about 150,000 AMU.

The molecular weight distribution of the hydrogenated block copolymer as measured by GPC is not particularly limited. The copolymer may have any ratio of weight average molecular weight to number average molecular weight.

Some of these hydrogenated block copolymers have a hydrogenated conjugated diene polymer chain to which crystallinity is ascribed. Crystallinity of the hydrogenated block copolymer can be determined by the use of a differential scanning calorimeter (DSC), for example, DSC-II Model manufactured by Perkin-Elmer Co. Heat of fusion can be measured by a heating rate of, for example, 10° C./min in an inert gas atmosphere such as nitrogen. For example, a sample may be heated to a temperature above an estimated melting point, cooled by decreasing the temperature at a rate of 10° C./min, allowed to stand for about 1 minute, and then heated again at a rate of 10° C./min.

The hydrogenated block copolymer may have any degree of crystallinity. In view of a balance of mechanical strength of the resulting resin composition, those hydrogenated block copolymers having a melting point of about −40° C. to about 160° C. or having no definite melting point (i.e., having non-crystallinity), as measured according to the above-described technique, are preferred. Within the melting point range of about −40° C. to about 160° C., it may be preferred to use a hydrogenated block copolymer having a melting point greater than or equal to about −20° C., more preferably greater than or equal to about 0° C., yet more preferably greater than or equal to about 20° C., still more preferably greater than or equal to about 40° C. Also within this range, it may be preferred to use a hydrogenated block copolymer having a melting point less than or equal to about 140° C., more preferably less than or equal to about 110° C., yet more preferably less than or equal to about 100° C.

The hydrogenated block copolymer may have any glass transition temperature (T_{g}) ascribed to the hydrogenated conjugated diene polymer chain. From the standpoint of low-temperature impact strength of the resulting resin composition, it preferably has a T_{g} of less than or equal to about −60° C., more preferably less than or equal to about −120° C. The glass transition temperature of the copolymer can be measured by the aforesaid DSC method or from the visco-elastic behavior toward temperature change as observed with a mechanical spectrometer.

Particularly preferred hydrogenated block copolymers are the styrene-(ethylene-butylene) diblock and styrene-(ethylene-butylene)-styrene triblock copolymers obtained by hydrogenation of styrene-butadiene and styrene-butadiene-styrene triblock copolymers, respectively.

The hydrogenated block copolymer may be synthesized by block polymerization followed by hydrogenation as described, for example, in U.S. Pat. No. 4,863,997 to Shibuya et al. Suitable hydrogenated block copolymers include, but are not limited to, styrene-(ethylene-propylene)-styrene triblock copolymers commercially available from KRATON Polymers as part of the KRATON G series, the styrene-(ethylene-butylene) diblock and styrene-(ethylene-butylene)-styrene triblock copolymers commercially available as part of the KRATON G series from KRATON Polymers and commercially available as, for example, TUFTEC® H1043 sold by Asahi Chemical.

The poly(arylene ether)/polyolefin blend may comprise the hydrogenated block copolymer in an amount of about 1 to about 20 weight percent, preferably about 1 to about 15 weight percent, more preferably about I to about 10 weight percent, based on the total combined weight of poly(arylene ether)/polyolefin blend and hydrogenated block copolymer.

When polyolefin is employed as the only thermoplastic resin in the under hood component, it comprises a reinforcing filler. When a poly(arylene ether)/polyolefin blend is employed in a under hood component it may further comprise a reinforcing filler. Reinforcing fillers may include, for example, inorganic and organic materials, such as fibers, woven fabrics and non-woven fabrics of the E-, NE-, S-, T- and D-type glasses and quartz; carbon fibers, including poly(acrylonitrile) (PAN) fibers, vapor-grown carbon fibers and graphitic vapor-grown carbon fibers having an average diameter of about 3 to about 500 nanometers (see, for example, U.S. Pat. Nos. 4,565,684 and 5,024,818 to Tibbetts et al., 4,572,813 to Arakawa; 4,663,230 and 5,165,909 to Tennent, 4,816,289 to Komatsu et al., 4,876,078 to Arakawa et al., 5,589,152 to Tennent et al., and 5,591,382 to Nahass et al.), potassium titanate single-crystal fibers, silicon carbide fibers, boron carbide fibers, gypsum fibers, aluminum oxide fibers, asbestos, iron fibers, nickel fibers, copper fibers, wollastonite fibers; and the like. The reinforcing fillers may be in the form of glass roving cloth, glass cloth, chopped glass, hollow glass fibers, glass mat, glass surfacing mat, non-woven glass fabric, ceramic fiber fabrics, long glass fibers, and metallic fiber fabrics. Long glass fibers are to be differentiated from other types of glass fibers in that they have an average fiber length of greater than or equal to about 0.5 inches (12 millimeters) prior to compounding. In addition, synthetic organic reinforcing fillers may also be used including organic polymers capable of forming fibers. Illustrative examples of such reinforcing organic fibers are poly(ether ketone), polyimide benzoxazole, poly(phenylene sulfide), polyesters, aromatic polyamides, aromatic polyimides or polyetherimides, acrylic resins, and poly(vinyl alcohol). Fluoropolymers such as polytetrafluoroethylene, may be used. Also included are natural organic fibers known to one skilled in the art, including cotton cloth, hemp cloth, and felt, carbon fiber fabrics, and natural cellulosic fabrics such as Kraft paper, cotton paper, and glass fiber containing paper. Such reinforcing fillers could be in the form of monofilament or multifilament fibers and could be used either alone or in combination with another type of fiber, through, for example, coweaving or core-sheath, side-by-side, orange-type or matrix and fibril constructions or by other methods known to one skilled in the art of fiber manufacture. They may be in the form of, for example, woven fibrous reinforcements, non-woven fibrous reinforcements, or papers.

In some embodiments the reinforcing filler may comprise a conductive filler. Conductive filler may be a conductive carbon fiber, carbon black, carbon nanotube or a combination of the foregoing. Various types of conductive carbon fibers are known in the art, and may be classified according to their diameter, morphology, and degree of graphitization (morphology and degree of graphitization being interrelated). These characteristics may be determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. These types of fibers have a relatively lower degree of graphitization.

Small carbon fibers having diameters from about 3 to about 2000 nanometers, and “tree-ring” or “fishbone” structures may be grown from hydrocarbons in the vapor phase, in the presence of particulate metal catalysts at moderate temperatures, i.e., about 800 to about 1500EC. Small carbon fibers are generally cylindrical, and have a hollow core. In the “tree-ring” structure a multiplicity of substantially graphitic sheets is coaxially arranged about the core, wherein the c-axis of each sheets is substantially perpendicular to the axis of the core. The interlayer correlation is generally low. In the “fishbone” structure, the fibers are characterized by graphite layers extending from the axis of the hollow core, as shown in EP 198 558 to Geus. A quantity of pyrolytically-deposited carbon may also be present on the exterior of the fiber.

Carbon nanotubes, in contrast, are presently produced by laser-evaporation of graphite or carbon arc synthesis, yielding fullerene-related structures which consist of graphene cylinders which may be open, or closed at either end with caps containing pentagonal and/or hexagonal rings. Nanotubes may consist of a single wall or have multiple concentrically-arranged walls, and have diameters of about 0.7 to about 2.4 nanometers (nm) for the single-wall nanotubes and about 2 to about 50 nanometers for the multi-wall nanotubes. In the multi-layer structure the cross-section of the hollow core becomes increasingly small with increasing numbers of layers. At diameters larger than about 10 to about 20 nanometers, multi-wall nanotubes begin to exhibit a hexagonal pillar shape, such that the curvature of the nanotubes becomes concentrated at the corners of the pillars. This arises from the interlayer correlation becoming established over a larger area with a structure close to that of graphite. This faceting is not found in the vapor-grown small carbon fibers described above, although it is possible to produce nanotubes from the vapor phase using much lower hydrocarbon pressures, and although the innermost tubes of some vapor grown carbon fibers are considered to be carbon nanotubes.

Carbon nanotubes produced by laser-evaporation of graphite or carbon arc synthesis may also be used. Nanotubes may consist of a single wall wherein the tube diameter is about 0.7 to about 2.4 nm or have multiple concentrically-arranged walls wherein the tube diameter is from about 2 to about 50 nm. When nanotubes are used it is preferred to have an average aspect ratio greater than or equal to about 5, preferably greater than about 100, more preferably greater than 1000. Representative carbon nanotubes are described in U.S. Pat. Nos. 6,183,714 to Smalley et al, 5,591,312 to Smalley, 5,641,455 to Ebbesen et al, 5,830,326 to Iijima et al, 5,591,832 to Tanaka et al, 5,919,429 to Tanaka et al.

Carbon black is a particulate, non-fibrous conductive filler commercially available under a variety of trade names, including but not limited to S.C.F. (Super Conductive Furnace), E.C.F. (Electric Conductive Furnace), Ketjen Black EC (available from Akzo Co., Ltd.) or acetylene black. Preferred carbon blacks are those having average particle sizes less than about 200 nm, preferably less than about 100 nm, more preferably less than about 50 nm. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Preferred conductive carbon blacks may be utilized in an amount of about 2 wt % to about 25 wt % based on the total weight of the composition.

Preferred reinforcing fillers include glass fibers. Preferred glass fibers may have diameters of about 2 to about 25 micrometers, more preferably about 10 to about 20 micrometers, yet more preferably about 13 to about 18 micrometers. Glass fibers comprising a sizing to increase their compatibility with the polyolefin or the poly(arylene ether) are particularly preferred. Suitable sizings are described, for example, in U.S. Pat. No. 5,998,029 to Adzima et al. Suitable glass fibers are commercially available as, for example, product numbers 147A-14P (14 micrometer diameter) and 147A-17P (17 micrometer diameter) from Owens Corning.

Preferred reinforcing fillers further include talc. There are no particular limitations on the physical characteristics of the talc. Preferred talcs may have an average particle size of about 0.5 to about 25 micrometers. Within this range, it may be preferred to use a talc having an average particle size less than or equal to about 10 micrometers, more preferably less than or equal to about 5 micrometers.

The compatibility of the reinforcing filler and the polyolefin may be improved not just with sizings on the surface of the reinforcing fillers, but also by adding to the composition a graft copolymer comprising a polyolefin backbone and polar grafts formed from one or more cyclic anhydrides. Such materials include graft copolymers of polyolefins (as defined above for the polyolefin component of the composition) and C₄-C₁₂ cyclic anhydrides, such as, for example, those available from ExxonMobil under the tradename EXXELOR® and from DuPont under the tradename FUSABOND®. Examples of suitable polyolefin-graft-cyclic anhydride copolymers are the polypropylene-graft-maleic anhydride materials supplied by ExxonMobil as EXXELOR® PO1020 and by DuPont as FUSABOND® M613-05. Suitable amounts of such materials may be readily determined and are generally about 0.1 to about 10 weight percent, based on the total weight of the composition. Within this range, a polyolefin-graft-cyclic anhydride copolymer amount greater than or equal to about 0.5 weight percent may be preferred. Also within this range, a polyolefin-graft-cyclic anhydride copolymer amount less than or equal to about 5 weight percent may be preferred.

Preferred reinforcing fillers further include organoclays. As used herein, an organoclay is a layered silicate clay, derived from layered minerals, in which organic structures have been chemically incorporated. Illustrative examples of organic structures are trimethyldodecylammonium ion and N,N′-didodecylimidazolium ion. Since the surfaces of clay layers, which have a lattice-like arrangement, are electrically charged, they are capable of binding organic ions. There is no limitation with respect to the layered minerals employed in this invention other than that they are capable of undergoing an ion exchange with the organic ions. Preferred organoclays include layered minerals that have undergone cation exchange with organocations and/or onium compounds. Illustrative of such layered minerals are the kaolinite group, the montmorillonite group, and the illite group which can include hydromicas, phengite, brammallite, glaucomite, celadonite and the like. Preferred layered minerals include those often referred to as 2:1 layered silicate minerals like muscovite, vermiculite, saponite, hectorite and montmorillonite, wherein montmorillonite is often preferred. The layered minerals described above may be synthetically produced. However, most often they are naturally occurring and commercially available. Organoclays and their preparation are described, for example, in U.S. Pat. Nos. 4,569,923, 4,664,842, 5,110,501, and 5,160,454 to Knudson, Jr. et al.; 5,530,052 and 5,773,502 to Takekoshi et al.; 5,780,376 to Gonzales et al.; 6,036,765 to Farrow et al.; 6,228,903 B1 to Beall et al.; and 6,262,162 B1 to Lan et al.

The thermoplastic composition comprises the reinforcing filler, when present, in an amount of about 1 to about 80 weight percent, preferably about 5 to about 40 weight percent, based on the total weight of the composition. When the reinforcing filler is an organoclay, it may be preferred to use it in an amount greater than or equal to about 5 weight percent, more preferably greater than or equal to about 10 weight percent. Also when the reinforcing filler is an organoclay, it may be preferred to use it in an amount less than or equal to about 45 weight percent, more preferably less than or equal to about 50 weight percent.

The poly(arylene ether)/polyolefin blends and reinforced polyolefin may, optionally, further comprise a polypropylene-polystyrene graft copolymer, a polypropylene-poly(arylene ether) graft copolymer with a polypropylene backbone, a polypropylene-poly(arylene ether) graft copolymer with a poly(arylene ether) backbone, or combinations of the foregoing graft copolymers. The polypropylene-polystyrene graft copolymer is herein defined as a graft copolymer having a propylene polymer backbone and one or more styrene polymer grafts.

The propylene polymer material that forms the backbone or substrate of the polypropylene-polystyrene graft copolymer or the polypropylene-poly(arylene ether) graft copolymer with a polypropylene backbone is (a) a homopolymer of propylene; (b) a random copolymer of propylene and an olefin selected from the group consisting of ethylene and C₄-C₁₀ olefins, provided that, when the olefin is ethylene, the polymerized ethylene content is less than or equal to about 10 weight percent, preferably less than or equal to about 4 weight percent, and when the olefin is a C₄-C₁₀ olefin, the polymerized content of the C₄-C₁₀ olefin is less than or equal to about 20 weight percent, preferably less than or equal to about 16 weight percent; (c) a random terpolymer of propylene and at least two olefins selected from the group consisting of ethylene and C₄-C₁₀ alpha-olefins, provided that the polymerized C₄-C₁₀ alpha-olefin content is less than or equal to about 20 weight percent, preferably less than or equal to about 16 weight percent, and, when ethylene is one of the olefins, the polymerized ethylene content is less than or equal to about 5 weight percent, preferably less than or equal to about 4 weight percent; or (d) a homopolymer or random copolymer of propylene which is impact-modified with an ethylene-propylene monomer rubber in the reactor as well as by physical blending, the ethylene-propylene monomer rubber content of the modified polymer being about 5 to about 30 weight percent, and the ethylene content of the rubber being about 7 to about 70 weight percent, and preferably about 10 to about 40 weight percent. The C₄-C₁₀ olefins include the linear and branched C₄-C₁₀ alpha-olefins such as, for example, 1-butene, 1-pentene, 3-methyl-1-butene, 4-methyl-1-pentene, 1-hexene, 3,4-dimethyl-1-butene, 1-heptene, 1-octene, 3-methyl-hexene, and the like. Propylene homopolymers and impact-modified propylene homopolymers are preferred propylene polymer materials. Although not preferred, propylene homopolymers and random copolymers impact modified with an ethylene-propylene-diene monomer rubber having a diene content of about 2 to about 8 weight percent also can be used as the propylene polymer material. Suitable dienes include dicyclopentadiene, 1,6-hexadiene, ethylidene norbornene, and the like.

The term “styrene polymer”, used in reference to the grafted polymer present on the backbone of propylene polymer material in the polypropylene-polystyrene graft copolymer, denotes (a) homopolymers of styrene or of an alkyl styrene having at least one C₁-C₄ linear or branched alkyl ring substituent, especially a p-alkyl styrene; (b) copolymers of the (a) monomers with one another in all proportions; and (c) copolymers of at least one (a) monomer with alpha-methyl derivatives thereof, e.g., alpha-methylstyrene, wherein the alpha-methyl derivative constitutes about 1 to about 40% of the weight of the copolymer.

The polypropylene-polystyrene graft copolymer will typically comprise about 10 to about 90 weight percent of the propylene polymer backbone and about 90 to about 10 weight percent of the styrene polymer graft. Within these ranges, the propylene polymer backbone may preferably account for greater than or equal to about 20 weight percent, of the total graft copolymer; and the propylene polymer backbone may preferably account for less than or equal to about 40 weight percent of the total graft copolymer. Also within these ranges, the styrene polymer graft may preferably account for greater than or equal to about 50 weight percent, more preferably greater than or equal to about 60 weight percent of the total graft copolymer.

The preparation of polypropylene-polystyrene graft copolymers is described, for example, in U.S. Pat. No. 4,990,558 to DeNicola, Jr. et al. Suitable polypropylene-polystyrene graft copolymers are also commercially available as, for example, P1045H1 and P1085H1 from Basell.

When present, the polypropylene-polystyrene graft copolymer, the polypropylene-poly(arylene ether) graft copolymer with a polypropylene backbone, the polypropylene-poly(arylene ether) graft copolymer with a poly(arylene ether) backbone, or a combination of the foregoing graft copolymers may be used in an amount of about 0.5 to about 20 weight percent, based on the total weight of the composition. Within this range, it may be preferred to use greater than or equal to about 1.0 weight percent of the polypropylene-polystyrene graft copolymer. Also within this range, it may also be preferred to use less than or equal to about 15 weight percent, more preferably less than or equal to about 10 weight percent, yet more preferably less than or equal to about 8 weight percent, of the graft copolymers.

The poly(arylene ether)/polyolefin blend may, optionally, further comprise an ethylene/alpha-olefin elastomeric copolymer. The alpha-olefin component of the copolymer may be at least one C₃-C₁₀ alpha-olefin. Preferred alpha-olefins include propylene, 1-butene, and 1-octene. The elastomeric copolymer may be a random copolymer having about 25 to about 75 weight percent ethylene and about 75 to about 25 weight percent alpha-olefin. Within these ranges, it may be preferred to use greater than or equal to about 40 weight percent ethylene; and it may be preferred to use less than or equal to about 60 weight percent ethylene. Also within these ranges, it may be preferred to use greater than or equal to about 40 weight percent alpha-olefin; and it may be preferred to use less than or equal to about 60 weight percent alpha-olefin. The ethylene/alpha-olefin elastomeric copolymer may typically have a melt flow index of about 0.1 to about 50 g/10 min, preferably about 0.1 to about 20 g/10 min, at 2.16 kg and 200° C., and a density of about 0.8 to about 0.9 g/ml.

Particularly preferred ethylene/alpha-olefin elastomeric copolymer rubbers include ethylene-propylene rubbers, ethylene-butylene rubbers, ethylene-octene rubbers, and mixtures thereof.

The ethylene/alpha-olefin elastomeric copolymer may be prepared according to known methods or obtained commercially as, for example, the neat ethylene-propylene rubber sold as VISTALON® 878 by ExxonMobil Chemical and the ethylene-butylene rubber sold as EXACT® 4033 by ExxonMobil Chemical. Ethylene/alpha-olefin elastomeric copolymers may also be obtained commercially as blends in polyolefins such as, for example, the ethylene-propylene rubber pre-dispersed in polypropylene sold as product numbers Profax 7624 and Profax 8623 from Basell, and the ethylene-butylene rubber pre-dispersed in polypropylene sold as Catalloy K021P from Basell.

When present, the ethylene/alpha-olefin elastomeric copolymer may be used in an amount of about 0.5 to about 25 weight percent, based on the total weight of the composition. Within this range, it may be preferred to use greater than or equal to about 1 weight percent, more preferably greater than or equal to about 3 weight percent, of the ethylene/alpha-olefin elastomeric copolymer. Also within this range, it may be preferred to use less than or equal to about 20 weight percent, more preferably less than or equal to about 15 weight percent, of the ethylene/alpha-olefin elastomeric copolymer.

Alternatively, the amount of ethylene/alpha-olefin elastomeric copolymer may be expressed as a fraction of the total of polyolefin and ethylene/alpha-olefin elastomeric copolymer. Thus, when the ethylene/alpha-olefin elastomeric copolymer is present, its amount may be expressed as about 1 to about 30 weight percent, preferably about 3 to about 30 weight percent, based on the combined weight of polyolefin and ethylene/alpha-olefin elastomeric copolymer.

The poly(arylene ether)/polyolefin blend may, optionally, further comprise an unhydrogenated block copolymer of alkenyl aromatic compound and a conjugated diene (referred to hereinafter as an “unhydrogenated block copolymer”). The unhydrogenated block copolymer is a copolymer comprising (A) at least one block derived from an alkenyl aromatic compound and (B) at least one block derived from a conjugated diene, in which the aliphatic unsaturated group content in the block (B) has not been reduced by hydrogenation. The alkenyl aromatic compound (A) and the conjugated diene (B) are defined in detail above in the description of the hydrogenated block copolymer. The arrangement of blocks (A) and (B) includes a linear structure and a so-called radial teleblock structure having a branched chain.

Preferred of these structures are linear structures embracing diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B. More preferred are diblock, triblock, and tetrablock structures, with the A-B-A triblock structure being particularly preferred.

The unhydrogenated block copolymer may comprise about 10 to about 90 weight percent of the (A) blocks. Within this range, it may be preferred to use greater than or equal to about 20 weight percent (A) blocks. Also within this range, it may be preferred to use less than or equal to about 50 percent (A) blocks.

Particularly preferred unhydrogenated block copolymers include styrene-butadiene diblock copolymers and styrene-butadiene-styrene triblock copolymers.

Suitable unhydrogenated block copolymers may be prepared by known methods or obtained commercially as, for example, KRATON® D series polymers, including KRATON® D1101 and D1102, from Kraton Polymers (formerly a division of Shell Chemical). Suitable unhydrogenated block copolymers further include the styrene-butadiene radial teleblock copolymers available as, for example, K-RESIN® KR01, KR03, KR05, and KR10 sold by Chevron Phillips Chemical Company.

When present, the unhydrogenated block copolymers may be used at about 0.5 to about 20 weight percent, based on the total weight of the composition. Within this range, it may be preferred to use greater than or equal to about 1 weight percent, more preferably greater than or equal to about 2 weight percent, of the unhydrogenated block copolymers. Also within this range, it may be preferred to use less than or equal to about 15 weight percent, preferably less than or equal to about 10 weight percent, of the unhydrogenated block copolymers.

The poly(arylene ether)/polyolefin blend may, optionally, further comprise a hydrogenated block copolymer of an alkenyl aromatic compound and a conjugated diene, wherein the hydrogenated block copolymer has an alkenyl aromatic content of about 10 to less than 40 weight percent. For this component, the alkenyl aromatic compound and the conjugated diene compound are the same as those defined above for the hydrogenated block copolymer having an alkenyl aromatic content of about 40 to about 90 weight percent. Such materials are commercially available as, for example, KRATON® G1650 and G1652 from Kraton Polymers. When present, the hydrogenated block copolymer having an alkenyl aromatic content of about 10 to less than 40 weight percent may be used at about 1 weight percent to about 20 weight percent, based on the total weight of the composition.

In addition to the components described above, the composition may comprise one or more additives known in the art. Such additives may include, for example, heat stabilizers, mold release agents, processing aids, flow promoters, flame retardants, drip retardants, nucleating agents, UV blockers, dyes, pigments, particulate fillers (i.e., fillers having an aspect ratio less than about 3), antioxidants, anti-static agents, blowing agents, and the like. Such additives are well known in the art and appropriate amounts may be readily determined.

The underhood components described herein are substantially free of polyimide, poly(arylene sulfide), polyester and polysiloxane. Substantially free is herein defined as containing less than 0.1 weight percent based on the total weight of the composition.

In one embodiment, an under hood component comprises a radiator end cap. The radiator end cap comprises: a poly(arylene ether); a poly(alkenyl aromatic) resin; optionally a rubber-modified poly(alkenyl aromatic) resin; a polyolefin; a hydrogenated block copolymer of alkenyl aromatic compound and a conjugated diene; a polyolefin-graft-cyclic anhydride copolymer; and a reinforcing filler such as glass fiber and/or carbon black.

The radiator end cap is not restricted in any way be design. Radiator end caps are generally employed in pairs and thus may be shaped so as to be affixed to the top and bottom of the radiator or to the sides of the radiator. It may be molded with one or more openings. Some of the openings may be shaped to facilitate the fluid communication between the radiator and other under hood components. Examples of which include nipples for the attachment of hoses or molded in hoses. Some openings may be shaped with a neck to facilitate attachment of a radiator cap. When a neck is present it may be shaped in any known in the art so as to facilitate the removable attachment of the cap, such as through the use of threads for screwing or other such removable attachment mechanisms such as a cam-lock or spring loaded twist and lock design. Additionally, the radiator end cap may shaped to comprise lips, edges, holes and the like so as to facilitate attachment of other components to the radiator and to facilitate attachment of the radiator to the vehicle.

As the thermoplastic resin is defined as comprising multiple components, it will be understood that each component is chemically distinct, particularly in the instance that a single chemical compound may satisfy the definition of more than one component.

The preparation of the thermoplastic resin is normally achieved by merely blending the ingredients under conditions for the formation of an intimate blend. Such conditions often include in-line compounding, particularly when long glass is employed as a filler, and mixing in single- or twin-screw type extruders or similar mixing devices that can apply a shear to the components.

The thermoplastic composition may be formed into under hood components by a variety of techniques. Useful techniques include but are not limited to injection molding, compression molding, in-line compounding, injection/compression molding, thermo forming, vacuum forming, blow molding, and gas assist injection molding. Injection molding is generally preferred for items such as radiator end caps. The invention is further illustrated by the following non-limiting examples. All patents cited above are herein incorporated by reference.

### EXAMPLES 1-3, COMPARATIVE EXAMPLE 1

Raw materials used in all example formulations are summarized in Table 1. Components 1-7, 9 and a portion of component 8 were thoroughly mixed and fed through a feeder and entered the extruder at the throat (extruder initial entry point). Unless otherwise specified, all component amounts are expressed in parts by weight. Components 10, 11 and the remainder of 8 were then fed into the extruder downstream (entry points were located after the feed throat).

Specific formulations of examples and comparative examples are given in Table 2. The examples were extruded using a 30 mm co-rotating twin screw extruder. Blends were melt extruded at 271° C., 450-500 rpm, and 136-25 kilograms pounds per hour. Melt from the extruder was forced through a 3-hole die to produce melt strands. These strands were rapidly cooled by passing them through a cold water bath. The cooled strands were chopped into pellets. Pellets were dried in the oven at 93° C. for 2-4 hours.

The comparative example utilizes VYDYNE® R525H, a glass reinforced polyamide available from Solutia, Inc. located in St. Louis, Mo.

Samples were formed into ASTM Type 1 tensile bars using a 120 tonne molding machine (manufacturer: Van Dorn) at 125° C. mold temp and a 232-288° C. barrel temperature. The bars were submersed for 32 days in a mixture containing 50% water and 50% extended life radiator coolant fluid. The sample bars and coolant fluid mixture were contained in sealed steel pipe. The steel pipe was held at 132° C. for 30 days and at ambient temperature for 2 days. The bars were removed from the sealed steel pipe and coolant fluid, wiped dry and tested for tensile strength at break according to ASTM D638 at room temperature.

TABLE 1

| Component | Material | Grade | Description | Source |
|---|---|---|---|---|
| 1 | PPE | 0.46 IV | poly(2,6-dimethylphenylene ether) | General Electric Company |
| 2 | Crystal PS | Chevron | homopolystyrene, MFR (200 C, 5 kg) = | Huntsman Chemical |
| | | EB3300 | 10.5 g/10 mins | |
| 3 | MgO | HS-810 | Magnesium oxide | Martin Marietta |
| 4 | ZnS | Sacholith | Zinc sulfide | Sachtleben Corp. |
| | | HD | | |
| 5 | Tridecylphos- | — | Anti-oxidant | GE Specialty Chemicals |
| | phite | | | |
| 6 | hi-S SEBS | TUFTEC ® | Contains about 66% PS | Asahi Chemical, distributed through |
| | | H1043 | | Marubeni America Corporation |
| 7 | Carbon black | Monarch | Filler | Cabot |
| | | 800 | | |
| 8 | PP-g-MA | EXXELOR ® | polypropylene with about 0.7 wt % | ExxonMobil |
| | | PO1020 | poly(maleic anhydride) grafts | |
| 9 | Polyterpene | Sylvares TP | Flow promoter | Arizona Chemical |
| | | 7042 | | |
| 10 | Glass fiber | 122Y 14C | Glass filler sized for used with | Owens Corning |
| | | | poly(arylene ether) | |
| 11 | PP | PP 3852 | Polypropylene homopolymer with an | Atofina |
| | | | MFI = 32 | |

TABLE 2

| | | | | Comparative |
|---|---|---|---|---|
| | Ex. 1 | Ex. 2 | Ex. 3 | Example |
| COMPOSITION | (PPX-11) | (PPX-6) | (PPX-2) | |
| PP-g-MA | 4.0 | 4.0 | 3.8 | |
| hi-S SEBS | 3.75 | 5.00 | 4.76 | |
| MgO | 0.05 | 0.05 | 0.05 | |
| Tridecyiphosphite | 0.15 | 0.15 | 0.15 | |
| PPE | 24.00 | 28.50 | 28.57 | |
| Polyterpene | 0.00 | 9.00 | 4.76 | |
| Crystal Polystyrene | 13.00 | 8.50 | 14.57 | |
| ZnS | 0.05 | 0.05 | 0.05 | |
| PP | 24.60 | 16.50 | 16.67 | |
| Carbon Black | 0.50 | 0.50 | 0.50 | |
| Glass fiber | 30.00 | 30.00 | 28.60 | |
| PROPERTIES | | | | |
| Tensile Strength at Break | 14038 | 14834 | 14553 | 19653 |
| (psi) before exposure | | | | |
| Tensile Strength at Break | 10576 | 11351 | 11510 | 1977 |
| (psi) after exposure | | | | |
| Retention of Tensile | 75 | 77 | 79 | 10 |
| strength (%) | | | | |

As can be seen by a comparison of Examples 1-3 to the Comparative Example, Examples 1-3 comprising a reinforced poly(arylene ether)/polyolefin blend show dramatic improvement in the retention of tensile strength when compared to the Comparative Example comprising reinforced polyamide.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. An under hood component comprising a poly(arylene ether)/polyolefin blend, a reinforced poly(arylene ether)/polyolefin blend or a combination of the foregoing.

2. The under hood component of claim 1, wherein the polyolefin comprises a homopolymer or copolymer having greater than or equal to about 80 weight percent of units derived from polymerization of ethylene, propylene, butylene, or a mixture thereof.

3. The under hood component of claims 1, wherein the polyolefin comprises a homopolymer of polypropylene, or a random, graft, or block copolymer of propylene and at least one olefin selected from ethylene and C₄-C₁₀ alpha-olefins, wherein the copolymer comprises greater than or equal to about 80 weight percent of repeating units derived from propylene.

4. The under hood component of claim 1, wherein the polyolefin comprises a homopolypropylene.

5. The under hood component of claim 1, wherein the poly(arylene ether) comprises a plurality of structural units of the formula 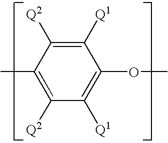
wherein for each structural unit, each Q¹ is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms.

6. The under hood component of claim 5, wherein each Q¹ is independently C₁-C₄ alkyl or phenyl, and each Q² is independently hydrogen or methyl.

7. The under hood component of claim 1, wherein the poly(arylene ether) is a copolymer of 2,6-dimethylphenol and 2,3,6-trimethylphenol.

8. The under hood component of claim 1, wherein the poly(arylene ether) is present at about 5 weight percent to about 95 weight percent, based on the total weight of the poly(arylene ether) and polyolefin.

9. The under hood component of claim 1 further comprising a hydrogenated alkenyl aromatic compound/conjugated diene block copolymer, an unhydrogenated alkenyl aromatic compound/conjugated diene block copolymer or a combination of a hydrogenated alkenyl aromatic compound/conjugated diene block copolymer and an unhydrogenated alkenyl aromatic compound/conjugated diene block copolymer.

10. The under hood component of claim 9, wherein the hydrogenated block copolymer comprises:
(A) at least one block derived from an alkenyl aromatic compound having the formula 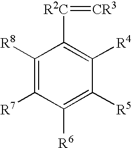
wherein R² and R³ each represent a hydrogen atom, a C₁-C₈ alkyl group, or a C₂-C₈ alkenyl group; R⁴ and R⁸ each represent a hydrogen atom, a C₁-C₈ alkyl group, a chlorine atom, or a bromine atom; and R⁵-R⁷ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group; and
(B) at least one block derived from a conjugated diene, in which the aliphatic unsaturated group content in the block (B) is reduced by hydrogenation.

11. The under hood component of claim 9, wherein the hydrogenated block copolymer comprises a styrene-(ethylene-butylene)-styrene triblock copolymer.

12. The under hood component of claim 9, wherein the hydrogenated block copolymer has a styrene content of about 50 to about 85 weight percent.

13. The under hood component of claim 9, wherein the hydrogenated block copolymer has a styrene content of about 55 to about 70 weight percent.

14. The under hood component of claim 9, wherein the hydrogenated block copolymer is present at about 1 weight percent to about 20 weight percent, based on the total weight of the composition.

15. The under hood component of claim 9, wherein the unhydrogenated block copolymer comprises a styrene-butadiene diblock copolymer or a styrene-butadiene-styrene triblock copolymer.

16. The under hood component of claim 9, wherein the unhydrogenated block copolymer of alkenyl aromatic compound and a conjugated diene is present at about 0.5 weight percent to about 20 weight percent, based on the total weight of the composition.

17. The under hood component of claim 1, further comprising a poly(alkenyl aromatic) resin.

18. The under hood component of claim 17, wherein the poly(alkenyl aromatic) resin comprises at least 25% by weight of structural units derived from an alkenyl aromatic monomer of the formula 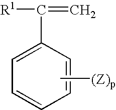
wherein R¹ is hydrogen, C₁-C₈ alkyl, or halogen; Z is vinyl, halogen, or C₁-C₈ alkyl; and p is 0 to 5.

19. The under hood component of claim 18 wherein the poly(alkenyl aromatic) resin comprises a poly(alkenyl aromatic) resin selected from the group consisting of atactic homopolystyrene, syndiotactic homopolystyrene, rubber-modified polystyrene, and mixtures comprising at least one of the foregoing poly(alkenyl aromatic) resins.

20. The under hood component of claim 17, wherein the poly(alkenyl aromatic) resin is present at about 1 weight percent to about 70 weight percent, based on the total weight of the blend.

21. The under hood component of claim 1 further comprising a polyolefin-graft-cyclic anhydride copolymer.

22. The under hood component of claim 21, wherein the polyolefin-graft-cyclic anhydride copolymer is a polypropylene-graft-maleic anhydride copolymer.

23. The under hood component of claim 21, wherein the polyolefin-graft-cyclic anhydride copolymer is present at about 0.1 to about 10 weight percent, based on the total weight of the composition.

24. The under hood component of claim 1, wherein the reinforced poly(arylene ether)/polyolefin blend comprises a reinforcing filler selected from the group consisting of glass fibers, long glass fibers, talc, quartz fibers, carbon fibers, potassium titanate fibers, silicon carbide fibers, boron carbide fibers, gypsum fibers, aluminum oxide fibers, iron fibers, nickel fibers, copper fibers, wollastonite fibers, poly(ether ketone) fibers, polyimide benzoxazole fibers, poly(phenylene sulfide) fibers, polyester fibers, aromatic polyamide fibers, aromatic polyimide fibers, aromatic polyetherimide fibers, acrylic fibers, poly(vinyl alcohol) fibers, polytetrafluoroethylene fibers, conductive filler and combinations of two or more of the foregoing reinforcing fillers.

25. The under hood component of claim 24, wherein the reinforcing filler comprises glass fibers having a diameter of about 2 to about 25 micrometers.

26. The under hood component of claim 24, wherein the reinforcing filler comprises a surface coating in an amount effective to increase compatibility with the polyolefin.

27. The under hood component of claim 24, wherein the reinforcing filler is present at about 1 weight percent to about 80 weight percent, based on the total weight of the composition.

28. The under hood component of claim 1 further comprising a polypropylene-polystyrene graft copolymer having a propylene polymer backbone and one or more styrene polymer grafts.

29. The under hood component of claim 28, wherein the polypropylene-polystyrene graft copolymer comprises about 10 to about 90 weight percent propylene polymer backbone and about 90 to about 10 weight percent styrene polymer grafts.

30. The under hood component of claim 28, wherein the polypropylene-polystyrene graft copolymer is present at about 0.5 weight percent to about 20 weight percent, based on the total weight of the composition.

31. The under hood component of claim 1, further comprising an ethylene/alpha-olefin elastomeric copolymer at about 0.5 weight percent to about 25 weight percent, based on the total weight of the composition.

32. The under hood component of claim 31, wherein the ethylene/alpha-olefin elastomeric copolymer comprises a copolymer of ethylene and at least one C₃-C₁₀ alpha-olefin.

33. The under hood component of claim 32, wherein the ethylene/alpha-olefin elastomeric copolymer comprises an ethylene-butylene rubber, an ethylene-propylene rubber, or a mixture thereof.

34. The under hood component of claim 1, further comprising an additive selected from the group consisting of stabilizers, mold release agents, processing aids, flow promoters, flame retardants, drip retardants, nucleating agents, UV blockers, dyes, pigments, particulate fillers, antioxidants, anti-static agents, blowing agents, and combinations comprising two or more of the foregoing additives.

35. An underhood component comprising
a poly(arylene ether)/polyolefin blend;
a hydrogenated alkenyl aromatic compound/conjugated diene block copolymer;
a poly(alkenyl aromatic) resin;
and a polyolefin-graft-cyclic anhydride copolymer.

36. A radiator end cap comprising:
a poly(arylene ether); a poly(alkenyl aromatic) resin; a rubber-modified poly(alkenyl aromatic) resin; a polyolefin; a hydrogenated block copolymer of alkenyl aromatic compound and a conjugated diene; a polyolefin-graft-cyclic anhydride copolymer; and a reinforcing filler.

37. A radiator end cap comprising a poly(arylene ether)/polyolefin blend, a reinforced polyolefin, a reinforced poly(arylene ether)/polyolefin blend or a combination of two or more of the foregoing.
